(19) United States
(12) Patent Application Publication
(10) Pub. No.: US 2020/0153108 A1
(43) Pub. Date: May 14, 2020

(54) WAVEGUIDE SLOT ARRAY ANTENNA

(71) Applicant: FUJIKURA LTD., Tokyo (JP)

(72) Inventor: Yusuke Uemichi, Sakura-shi (JP)

(73) Assignee: FUJIKURA LTD., Tokyo (JP)

(21) Appl. No.: 16/625,016

(22) PCT Filed: Apr. 5, 2018
(86) PCT No.: PCT/JP2018/014612

§ 371 Date: Dec. 20, 2019

(30) Foreign Application Priority Data
Jul. 6, 2017 (JP) 2017-133003

(51) Int. Cl. H01Q 21/00; H01Q 13/10; H01P 5/12; H01Q 1/38; H01P 3/12

(52) U.S. Cl. CPC H01Q 21/005; H01Q 13/106; H01P 3/121; H01Q 1/38; H01P 5/12

(57) ABSTRACT

A waveguide slot array antenna whose plan view size is smaller than that of a conventional waveguide slot array antenna is realized. A waveguide slot array antenna (1) includes: a split circuit board (11) to which a post-wall waveguide (113a) is provided, the post-wall waveguide (113a) being configured to cause an electromagnetic wave, inputted through an input opening (111a), to be split; and an antenna circuit board (12) to which a post-wall waveguide (123a) is provided, the post-wall waveguide (123a) being configured to guide, to a slot array (122a), the electromagnetic wave split in the post-wall waveguide (113a). The split circuit board (11) and the antenna circuit board (12) are joined to each other so that the post-wall waveguide (113a) and the post-wall waveguide (123a) at least overlap each other.

### TECHNICAL FIELD

The present invention relates to a waveguide slot array antenna.

### BACKGROUND ART

As antennas which can be used for a microwave band or a millimeter wave band, waveguide slot array antennas are known. A waveguide slot array antenna includes (1) a dielectric layer in which a waveguide is formed, (2) a first conductor layer which covers a lower surface of the dielectric layer, (3) a second conductor layer which covers an upper surface of the dielectric layer and in which a slot array is formed. An electromagnetic wave inputted into the waveguide is radiated through the slot array. In a case where the slot array is distributed two-dimensionally, a branch is provided to the waveguide. Non-Patent Literature 1 discloses such a waveguide slot array antenna.

FIG. 9 is a plan view of a waveguide slot array antenna 9 disclosed in Non-Patent Literature 1. The waveguide slot array antenna 9 includes (i) a three-stage branch waveguide 9a obtained by coupling a T branch, Y branches, and T branches together and (ii) an output waveguide group 9b constituted by eight output waveguides. An electromagnetic wave inputted through an opening 9c is guided to the output waveguide group 9b through the branch waveguide 9a, and is radiated through a slot array.

### CITATION LIST

### Non-Patent Literature

[Non-Patent Literature 1]

N. Athanasopoulos, D. Makris, K. Voudouris, “Design and Development of 60 GHz Millimeter-wave Passive Components using Substrate Integrated Waveguide Technology”, 2nd Pan-Hellenic Conference on Electronics and Telecommunications—PACKET '12, Mar. 16-18, 2012, Thessaloniki, Greece

### SUMMARY OF INVENTION

### Technical Problem

However, according to the waveguide slot array antenna 9 of a conventional technique, the branch waveguide 9a and the output waveguide group 9b need to be formed so as to be arranged in an identical dielectric layer. This disadvantageously causes a size of the waveguide slot array antenna 9 in a plan view (hereinafter, referred to as a “plan view size”) to be large. This problem becomes more remarkable as the number of output waveguides is increased so as to increase antenna gain. This is because it is necessary to increase the number of stages in a branch waveguide in order to increase the number of output waveguides and, consequently, it is necessary to increase the plan view size of the waveguide slot array antenna 9.

The present invention has been made in view of the above problem, and the object of the present invention is to realize a waveguide slot array antenna whose plan view size is smaller than that of a conventional waveguide slot array antenna.

### Solution to Problem

In order to attain the above object, a waveguide slot array antenna in accordance with an aspect of the present invention is a waveguide slot array antenna, including: a first substrate to which a first waveguide is provided, the first waveguide being configured to cause an electromagnetic wave, inputted through an input opening, to be split; and a second substrate to which a second waveguide is provided, the second waveguide being configured to guide, to a slot array, the electromagnetic wave split in the first waveguide, the first substrate and the second substrate being joined to each other so that the first waveguide and the second waveguide at least overlap each other.

### Advantageous Effects of Invention

According to an aspect of the present invention, it is possible to realize a waveguide slot array antenna whose plan view size is smaller than that of a conventional waveguide slot array antenna.

### BRIEF DESCRIPTION OF DRAWINGS

FIG. 1 is an exploded perspective view of a waveguide slot array antenna in accordance with an embodiment of the present invention.

FIG. 2 is a plan view of a split circuit board of the waveguide slot array antenna illustrated in FIG. 1.

FIG. 3 is a plan view of an antenna circuit board of the waveguide slot array antenna illustrated in FIG. 1.

FIG. 4 is a drawing illustrating a configuration of a connection between the split circuit board and the antenna circuit board which are included in the waveguide slot array antenna illustrated in FIG. 1. (a) of FIG. 4 is a perspective view of the connection between the split circuit board and the antenna circuit board. (b) of FIG. 4 is a cross-sectional view of the connection between the split circuit board and the antenna circuit board.

FIG. 5 is a graph showing a frequency characteristic of an electromagnetic wave radiated from the waveguide slot array antenna illustrated in FIG. 1.

FIG. 6 is an exploded perspective view illustrating Variation 1 of the waveguide slot array antenna illustrated in FIG. 1.

FIG. 7 is an exploded perspective view illustrating Variation 2 of the waveguide slot array antenna illustrated in FIG. 1.

FIG. 8 is a cross-sectional view of a waveguide slot array antenna illustrated in FIG. 7.

FIG. 9 is a plan view of a conventional waveguide slot array antenna.

### DESCRIPTION OF EMBODIMENTS

[Configuration of Waveguide Slot Array Antenna]

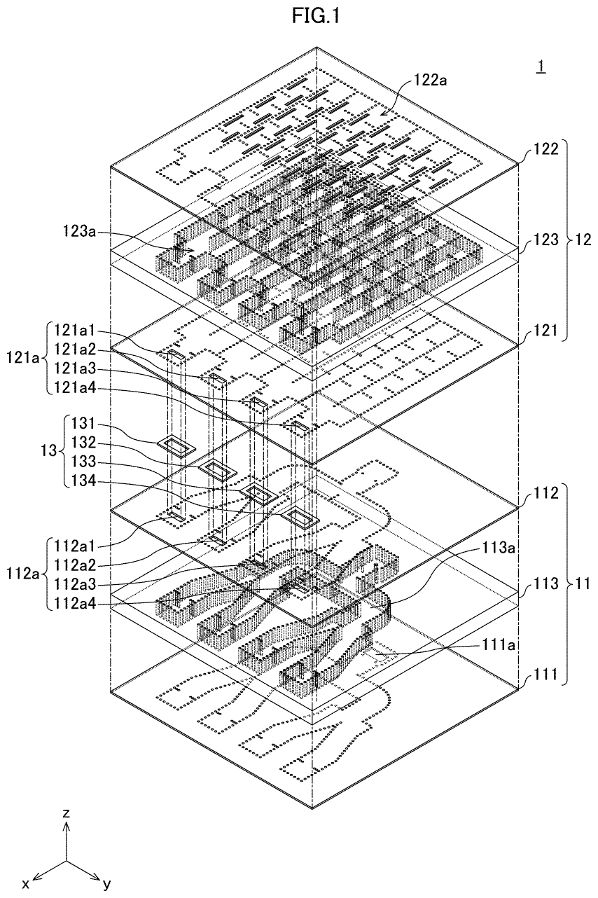

A configuration of a waveguide slot array antenna 1 in accordance with Embodiment 1 of the present invention will be described below with reference to FIG. 1. FIG. 1 is an exploded perspective view of the waveguide slot array antenna 1 in accordance with Embodiment 1.

As illustrated in FIG. 1, the waveguide slot array antenna 1 includes a split circuit board 11 (an example of a “first substrate” recited in the claims), an antenna circuit board 12 (an example of a “second substrate” recited in the claims), and a joining layer 13. The split circuit board 11 and the antenna circuit board 12 are provided so as to be stacked up, and are joined to each other via the joining layer 13.

The split circuit board 11 is constituted by a first dielectric layer 113, a first conductor layer 111 which covers a lower surface of the first dielectric layer 113, and a second conductor layer 112 which covers an upper surface of the first dielectric layer 113, thereby realizing, as a thin substrate, a function of a split circuit. A material of each of the first conductor layer 111 and the second conductor layer 112 can be, for example, metal such as copper. A material of the first dielectric layer 113 can be, for example, glass such as quartz glass.

An input opening 111a is formed in the first conductor layer 111. An output opening group 112a constituted by output openings 112a1 through 112a4 (in Embodiment 1, four output openings) is formed in the second conductor layer 112. A post-wall waveguide 113a (an example of a “first waveguide” recited in the claims) which causes an electromagnetic wave, inputted through the input opening 111a, to be split is formed in the first dielectric layer 113. The electromagnetic wave split in the post-wall waveguide 113a is outputted through output opening group 112a. A more specific configuration of the split circuit board 11 will be later described with reference to another drawing.

The antenna circuit board 12 is constituted by a second dielectric layer 123, a third conductor layer 121 which covers a lower surface of the second dielectric layer 123, and a fourth conductor layer 122 which covers an upper surface of the second dielectric layer 123, thereby realizing, as a thin substrate, a function of a slot array antenna. A material of each of the third conductor layer 121 and the fourth conductor layer 122 can be, for example, metal such as copper. A material of the second dielectric layer 123 can be, for example, glass such as quartz glass.

An input opening group 121a constituted by input openings 121a1 through 121a4, the number of which is identical to that of the output openings 112a1 through 112a4 of the split circuit board 11, is formed in the third conductor layer 121. A slot array 122a constituted by slots 122a1 through 122a48 (in Embodiment 1, 48 slots), which are arranged in an array, is formed in the fourth conductor layer 122. A post-wall waveguide 123a (an example of a “second waveguide” recited in the claims) which guides, to the slot array 122a, an electromagnetic wave inputted through the input opening group 121a is formed in the second dielectric layer 123. A more specific configuration of the antenna circuit board 12 will be later described with reference to another drawing.

The split circuit board 11 and the antenna circuit board 12 are joined to each other so that (1) the second conductor layer 112 of the split circuit board 11 face the third conductor layer 121 of the antenna circuit board 12 and (2) the output openings 112a1 through 112a4 of the second conductor layer 112 are in alignment with the input openings 121a1 through 121a4, respectively, of the third conductor layer 121. This causes the post-wall waveguide 113a of the split circuit board 11 to be coupled to the post-wall waveguide 123a of the antenna circuit board 12 via the output openings 112a1 through 112a4 and the input openings 121a1 through 121a4. That is, an electromagnetic wave outputted from the split circuit board 11 through the output opening group 112a is inputted into the antenna circuit board 12 through the input opening group 121a.

The split circuit board 11 and the antenna circuit board 12 are joined to each other via the joining layer 13. The joining layer 13 is constituted by first through fourth joining conductors 131 through 134 (an example of a “connecting conductors” recited in the claims), the number of which is identical to that of the output openings 112a1 through 112a4 of the split circuit board 11 and to that of the input openings 121a1 through 121a4 of the antenna circuit board 12. The first joining conductor 131 is an annular conductor which surrounds the output opening 112a1 of the split circuit board 11 and the input opening 121a1 of the antenna circuit board 12. The second joining conductor 132 is an annular conductor which surrounds the output opening 112a2 of the split circuit board 11 and the input opening 121a2 of the antenna circuit board 12. The third joining conductor 133 is an annular conductor which surrounds the output opening 112a3 of the split circuit board 11 and the input opening 121a3 of the antenna circuit board 12. The fourth joining conductor 134 is an annular conductor which surrounds the output opening 112a4 of the split circuit board 11 and the input opening 121a4 of the antenna circuit board 12. A material of each of the joining conductors 131 through 134 can be, for example, a solder powder, a copper powder, or a mixture thereof. In Embodiment 1, a mixture of a solder powder (Sn-3.0Ag-0.5Cu) having a particle size of φ15 μm to φ25 μm and a copper powder having a particle size of φ15 μm to φ25 μm is used as the material of each of the joining conductors 131 through 134. A function of each of the joining conductors 131 through 134 will be later described with reference to another drawing.

In the waveguide slot array antenna 1 in accordance with Embodiment 1, the split circuit board 11 and the antenna circuit board 12 are joined to each other so that the post-wall waveguide 113a of the split circuit board 11 and the post-wall waveguide 123a of the antenna circuit board 12 at least overlap each other. Therefore, it is possible to make a plan view size of the waveguide slot array antenna 1 smaller than that of a conventional waveguide slot array antenna having a branch waveguide similar to the post-wall waveguide 113a.

In particular, in the waveguide slot array antenna 1 in accordance with Embodiment 1, the split circuit board 11 and the antenna circuit board 12 are joined to each other so that a direction in which an electromagnetic wave travels in the post-wall waveguide 113a of the split circuit board 11 is opposite to a direction in which an electromagnetic wave travels in the post-wall waveguide 123a of the antenna circuit board 12. Therefore, it is possible to increase a proportion of a part of the post-wall waveguide 113a of the split circuit board 11 which part overlaps the post-wall waveguide 123a of the antenna circuit board 12, as compared with a case where these two travelling directions are identical to each other. This makes it possible to further reduce the plan view size of the waveguide slot array antenna 1.

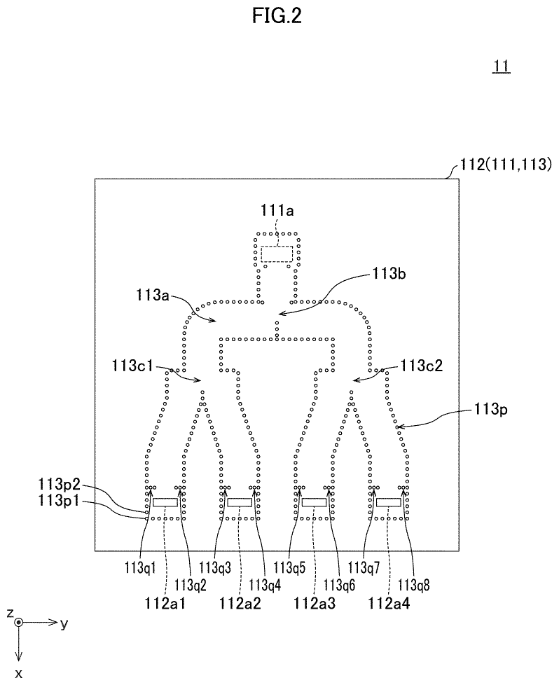

Note that a coordinate system defined as below relative to a T branch 113b (see FIG. 2) included in the split circuit board 11 will be used throughout the specification. That is, an axis parallel to a waveguide axis of an input waveguide of the T branch 113b is defined as an x axis. An axis parallel to a waveguide axis of an output waveguide of the T branch 113b included in the split circuit board 11 is defined as a y axis. An axis perpendicular to the x axis and the y axis is defined as a z axis. A direction of the x axis is defined such that a travelling direction of an electromagnetic wave in the input waveguide of the T branch 113b is positive. Directions of the y axis and the z axis are defined such that the directions of the y axis and the z axis constitute a right-hand system. Note also that, throughout the specification, a positive direction of the z axis will be referred to as “up” and a negative direction of the z axis will be referred to as “down”. Note also that viewing the waveguide slot array antenna 1 from the positive direction of the z axis will be referred to as “viewing from above”. Note, however, that these designations are given merely for simplification of explanation, and arrangement of the waveguide slot array antenna 1 is not limited by these designations. In the coordinate system thus defined, a travelling direction of an electromagnetic wave in the post-wall waveguide 113a of the split circuit board 11 is a positive direction of the x axis. A travelling direction of an electromagnetic wave in the post-wall waveguide 123a of the antenna circuit board 12 is a negative direction of the x axis.

[Configuration of Split Circuit Board]

A configuration of the split circuit board 11 included in the waveguide slot array antenna 1 will be described below, in more detail, with reference to FIG. 2. FIG. 2 is a plan view of the split circuit board 11 as viewed from above.

The input opening 111a through which an electromagnetic wave is inputted is formed in the first conductor layer 111. In Embodiment 1, the input opening 111a has a shape of a rectangle having a short side parallel to the x axis and a long side parallel to the y axis in the coordinate system illustrated. Hereinafter, an electromagnetic wave inputted into the split circuit board 11 through the input opening 111a will be also referred to as a “first input wave”.

The output opening group 112a through which an electromagnetic wave is outputted is formed in the second conductor layer 112. The output opening group 112a is constituted by the output openings 112a1 through 112a4 which are arranged along the y axis in the coordinate system illustrated. In Embodiment 1, each of the output openings 112a1 through 112a4 has a shape of a rectangle having a short side parallel to the x axis and a long side parallel to the y axis in the coordinate system illustrated. Hereinafter, an electromagnetic wave outputted from the split circuit board 11 through each of the output openings 112a1 through 112a4 will be also referred to as a “first output wave”.

The post-wall waveguide 113a is formed in the first dielectric layer 113. The post-wall waveguide 113a is a waveguide having (i) the first conductor layer 111 and the second conductor layer 112 as wide walls and (ii) a post wall 113p, formed in the first dielectric layer 113, as a narrow wall.

The post wall 113p is a set of conductor posts 113p1, 113p2, . . . which are arranged in the form of a fence. A conductor post 113pi (i=1, 2, . . . ) is a cylindrical conductor or a tubular conductor, and has (i) a lower end short-circuited to the first conductor layer 111 and (ii) an upper end short-circuited to the second conductor layer 112. In Embodiment 1, a conductor plating which is formed on a wall surface of a through-hole passing through the first dielectric layer 113 is used as the conductor post 113pi. A distance between two adjacent conductor posts (for example, a distance between the conductor post 113p1 and the conductor post 113p2) is set so as to be sufficiently shorter than a wavelength of an electromagnetic wave which propagates through the post-wall waveguide 113a. Use of such a post wall 113p allows realization of a narrow wall which has a function equivalent to that of a conductor wall and which is lighter in weight than the conductor wall.

The post-wall waveguide 113a includes the T branch 113b, a first Y branch 113c1, and a second Y branch 113c2. The T branch 113b causes a first input wave, inputted through the input opening 111a, to be split into two intermediate waves. The first Y branch 113c1 causes one of the two intermediate waves to be split into two first output waves which are outputted through the respective output openings 112a1 and 112a2. The second Y branch 113c2 causes the other of the two intermediate waves to be split into two first output waves which are outputted through the respective output openings 112a3 and 112a4.

The post wall 113p has (1) a pair of barriers 113q1 and 113q2 for narrowing, in a vicinity of the output opening 112a1, one of output waveguides of the first Y branch 113c1, (2) a pair of barriers 113q3 and 113q4 for narrowing, in a vicinity of the output opening 112a2, the other of the output waveguides of the first Y branch 113c1, (3) a pair of barriers 113q5 and 113q6 for narrowing, in a vicinity of the output opening 112a3, one of output waveguides of the second Y branch 113c2, and (4) a pair of barriers 113q7 and 113q8 for narrowing, in a vicinity of the output opening 112a4, the other of the output waveguides of the second Y branch 113c2. A function of each of those barriers 113q1 through 113q8 will be later described with reference to another drawing.

[Configuration of Antenna Circuit Board]

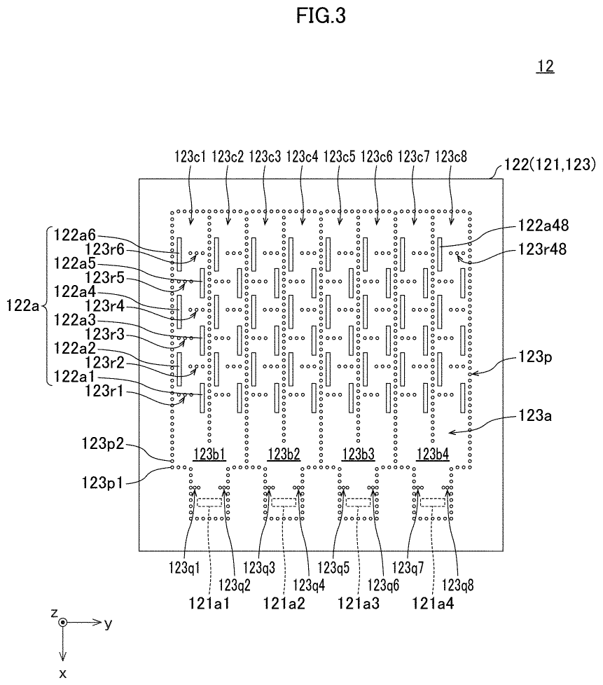

A configuration of the antenna circuit board 12 included in the waveguide slot array antenna 1 will be described below, in more detail, with reference to FIG. 3. FIG. 3 is a plan view of the antenna circuit board 12 as viewed from above.

The input opening group 121a through which an electromagnetic wave is inputted is formed in the third conductor layer 121. The input opening group 121a is constituted by the input openings 121a1 through 121a4 which are arranged along the y axis in the coordinate system illustrated. A shape of each of the input openings 121a1 through 121a4 is identical to that of each of the output openings 112a1 through 112a4 of the split circuit board 11. Hereinafter, an electromagnetic wave inputted into the antenna circuit board 12 through each of the input openings 121a1 through 121a4 will be also referred to as a “second input wave”.

The slot array 122a through which an electromagnetic wave is radiated is formed in the fourth conductor layer 122. The slot array 122a is constituted by the slots 122a1 through 122a48 (in Embodiment 1, 48 slots), which are arranged in an array. In Embodiment 1, each of the slots 122a1 through 122a48 has a shape of a rectangle having a short side parallel to the y axis and a long side parallel to the x axis in the coordinate system illustrated. Note that FIG. 2 does not show reference signs of the slots 122a7 through 122a47 so that complication of FIG. 2 is avoided.

The post-wall waveguide 123a is formed in the second dielectric layer 123. The post-wall waveguide 123a is a waveguide having (i) the third conductor layer 121 and the fourth conductor layer 122 as wide walls and (ii) a post wall 123p, formed in the second dielectric layer 123, as a narrow wall.

The post wall 123p is a set of conductor posts 123p1, 123p2, . . . which are arranged in the form of a fence. A conductor post 123pj (j=1, 2, . . . ) is a cylindrical conductor or a tubular conductor, and has (i) a lower end short-circuited to the third conductor layer 121 and (ii) an upper end short-circuited to the fourth conductor layer 122. In Embodiment 1, a conductor plating which is formed on a wall surface of a through-hole passing through the second dielectric layer 123 is used as the conductor post 123pj. A distance between two adjacent conductor posts (for example, a distance between the conductor post 123p1 and the conductor post 123p2) is set so as to be sufficiently shorter than a wavelength of an electromagnetic wave which propagates through the post-wall waveguide 123a. Use of such a post wall 123p allows realization of a narrow wall which has a function equivalent to that of a conductor wall and which is lighter in weight than the conductor wall.

The post-wall waveguide 123a includes first through fourth Y branches 123b1 through 123b4 and first through eighth output waveguides 123c1 through 123c8. The first Y branch 123b1 causes a second input wave, inputted through the input opening 121a1, to be split into two second output waves. The first output waveguide 123c1 guides one of the two second output waves, and the second output waveguide 123c2 guides the other of the two second output waves. The second Y branch 123b2 causes a second input wave, inputted through the input opening 121a2, to be split into two second output waves. The third output waveguide 123c3 guides one of the two second output waves, and the fourth output waveguide 123c4 guides the other of the two second output waves. The third Y branch 123b3 causes a second input wave, inputted through the input opening 121a3, to be split into two second output waves. The fifth output waveguide 123c5 guides one of the two second output waves, and the sixth output waveguide 123c6 guides the other of the two second output waves. The fourth Y branch 123b4 causes a second input wave, inputted through the input opening 121a4, to be split into two second output waves. The seventh output waveguide 123c7 guides one of the two second output waves, and the eighth output waveguide 123c8 guides the other of the two second output waves. Those second output waves guided through the first through eighth output waveguides 123c1 through 123c8 are radiated through the slot array 122a.

The post wall 123p has (1) a pair of barriers 123q1 and 123q2 for narrowing, in a vicinity of the input opening 121a1, an input waveguide of the first Y branch 123b1, (2) a pair of barriers 123q3 and 123q4 for narrowing, in a vicinity of the input opening 121a2, an input waveguide of the second Y branch 123b2, (3) a pair of barriers 123q5 and 123q6 for narrowing, in a vicinity of the input opening 121a3, an input waveguide of the third Y branch 123b3, and (4) a pair of barriers 123q7 and 123q8 for narrowing, in a vicinity of the input opening 121a4, an input waveguide of the fourth Y branch 123b4. A function of each of those barriers 123q1 through 123q8 will be later described with reference to another drawing.

Further, the post wall 123p includes, as branches, (1) barriers 123r1 through 123r6 for causing the first output waveguide 123c1 to wind, (2) barriers 123r7 through 123r12 for causing the second output waveguide 123c2 to wind, (3) barriers 123r13 through 123r18 for causing the third output waveguide 123c3 to wind, (4) barriers 123r19 through 123r24 for causing the fourth output waveguide 123c4 to wind, (5) barriers 123r25 through 123r30 for causing the fifth output waveguide 123c5 to wind, (6) barriers 123r31 through 123r36 for causing the sixth output waveguide 123c6 to wind, (7) barriers 123r37 through 123r42 for causing the seventh output waveguide 123c7 to wind, and (8) barriers 123r43 through 123r48 for causing the eighth output waveguide 123c8 to wind. Note that FIG. 2 does not show reference signs of the barriers 123r7 through 123r47 so that complication of FIG. 2 is avoided

In the first output waveguide 123c1, the barriers 123r1 through 123r6 and the slots 122a1 through 122a6 are arranged as follows.

The barriers 123r1 through 123r6 are arranged in a staggered manner. More specifically, the barriers 123r1, 123r3, and 123r5, which are odd-numbered from an input-opening-121a1 side, are each provided so as to extend in a positive direction of the y axis from a side wall of the first output waveguide 123c1 which side wall is located in a negative direction of the y axis. The barriers 123r2, 123r4, and 123r6, which are even-numbered from the input-opening-121a1 side, are each provided so as to extend in the negative direction of the y axis from a side wall of the first output waveguide 123c1 which side wall is located in the positive direction of the y axis. A length of each of the barriers 123r1 through 123r6 (length measured along the y axis) is longer than half of a width of the first output waveguide 123c1, and shorter than the width of the first output waveguide 123c1. The output waveguide 123c1 is sectioned into seven sections by the barriers 123r1 through 123r6.

The slots 122a1 through 122a6 are arranged in a staggered manner so that the slots 122a1 through 122a6 are complementary with respect to the barriers 123r1 through 123r6, respectively. More specifically, the slot 122a1 is provided so that the slot 122a1 (i) straddles a boundary between two sections sectioned by the barrier 123r1 and (ii) does not overlap the barrier 123r1. The slot 122a2 is provided so that the slot 122a2 (i) straddles a boundary between two sections sectioned by the barrier 123r2 and (ii) does not overlap the barrier 123r2. The slot 122a3 is provided so that the slot 122a3 (i) straddles a boundary between two sections sectioned by the barrier 123r3 and (ii) does not overlap the barrier 123r3. The slot 122a4 is provided so that the slot 122a4 (i) straddles a boundary between two sections sectioned by the barrier 123r4 and (ii) does not overlap the barrier 123r4. The slot 122a5 is provided so that the slot 122a5 (i) straddles a boundary between two sections sectioned by the barrier 123r5 and (ii) does not overlap the barrier 123r5. The slot 122a6 is provided so that the slot 122a6 (i) straddles a boundary between two sections sectioned by the barrier 123r6 and (ii) does not overlap the barrier 123r6.

Note that pitches with which the barriers 123r1 through 123r6 and the slots 122a1 through 122a6 are arranged are determined so that a reflected wave caused by one of adjacent two slots (for example, the slot 122a1 and the slot 122a2) and a reflected wave caused by the other of the two slots are in antiphase. This allows minimization of a reflected wave caused by each of the slots 122a1 through 122a6.

By thus arranging the barriers 123r1 through 123r6 and the slots 122a1 through 122a6, it is possible to cause an electromagnetic wave propagating through the first output waveguide 123c1 to be effectively radiated through the slots 122a1 through 122a6. Such arrangement of the barriers 123r1 through 123r6 and the slots 122a1 through 122a6 in the first output waveguide 123c1 also applies to (1) arrangement of the barriers 123r7 through 123r12 and the slots 122a7 through 122a12 in the second output waveguide 123c2, (2) arrangement of the barriers 123r13 through 123r18 and the slots 122a13 through 122a18 in the third output waveguide 123c3, (3) arrangement of the barriers 123r19 through 123r24 and the slots 122a19 through 122a24 in the fourth output waveguide 123c4, (4) arrangement of the barriers 123r25 through 123r30 and the slots 122a25 through 122a30 in the fifth output waveguide 123c5, (5) arrangement of the barriers 123r31 through 123r36 and the slots 122a31 through 122a36 in the sixth output waveguide 123c6, (6) arrangement of the barriers 123r37 through 123r42 and the slots 122a37 through 122a42 in the seventh output waveguide 123c7, and (7) arrangement of the barriers 123r43 through 123r48 and the slots 122a43 through 122a48 in the eighth output waveguide 123c8.

[Configuration of Connection]

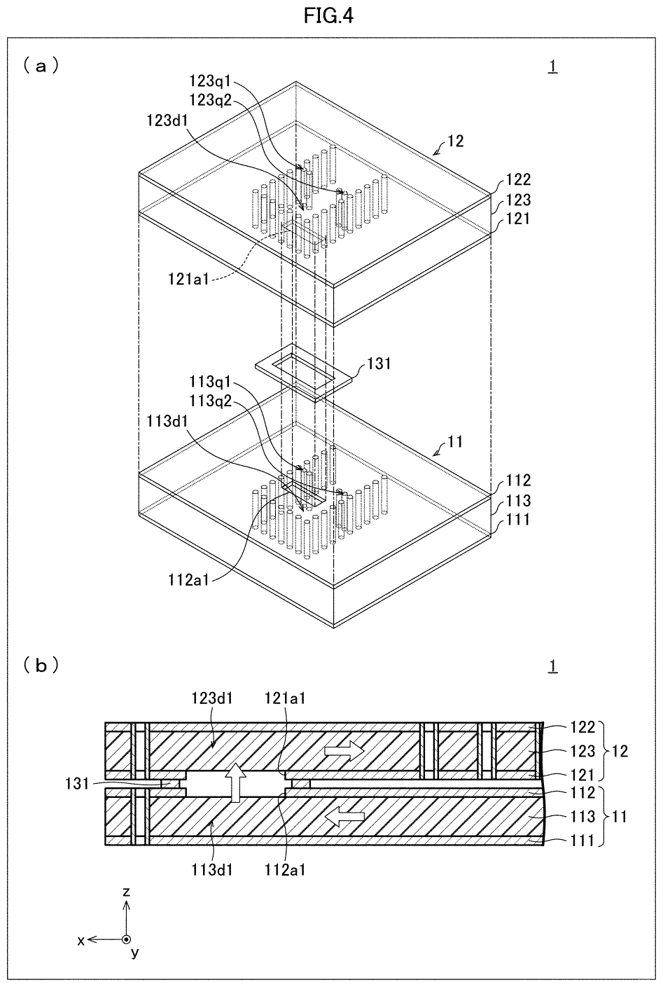

A configuration of a connection of the waveguide slot array antenna 1 will be described below, in detail, with reference to FIG. 4. (a) of FIG. 4 is a perspective view of the connection of the waveguide slot array antenna 1. (b) of FIG. 4 is a cross-sectional view of the connection of the waveguide slot array antenna 1.

In the waveguide slot array antenna 1, the split circuit board 11 and the antenna circuit board 12 are provided so that (1) the second conductor layer 112 of the split circuit board 11 faces the third conductor layer 121 of the antenna circuit board 12 and (2) the output opening 112a1 of the second conductor layer 112 is in alignment with the input opening 121a1 of the third conductor layer 121 when the waveguide slot array antenna 1 is viewed from above. The joining conductor 131, which joins the second conductor layer 112 of the split circuit board 11 to the third conductor layer 121 of the antenna circuit board 12, surrounds the output opening 112a1 of the second conductor layer 112 and the input opening 121a1 of the third conductor layer 121. Therefore, an electromagnetic wave outputted from the split circuit board 11 through the output opening 112a1 is inputted into the antenna circuit board 12 through the input opening 121a1 without leaking to a chink between the split circuit board 11 and the antenna circuit board 12.

Note that a space surrounded by the joining conductor 131 as well as an inside of the output opening 112a1 and an inside of the input opening 121a1 can be filled with air or can be alternatively filled with an dielectric material other than air. Preferable examples of the dielectric material with which the space surrounded by the joining conductor 131 is filled include dielectric materials which have dielectric constants equal to or substantially equal to those of the first dielectric layer 113 and the second dielectric layer 123. This makes it possible to broaden a transmission bandwidth of a band-pass filter constituted by resonators 113d1 and 123d1 (later described).

In the waveguide slot array antenna 1, the post wall 113p of the split circuit board 11 includes the pair of barriers 113q1 and 113q2 for narrowing, in the vicinity of the output opening 112a1, the post-wall waveguide 113a. Therefore, a region in the post-wall waveguide 113a of the split circuit board 11, which region is surrounded by the post wall 113p and the barriers 113q1 and 113q2 and is located in the vicinity of the output opening 112a1, functions as the resonator 113d1. Similarly, the post wall 123p of the antenna circuit board 12 includes the pair of barriers 123q1 and 113q2 for narrowing, in the vicinity of the input opening 121a1, the post-wall waveguide 123a. Therefore, a region in the post-wall waveguide 123a of the antenna circuit board 12, which region is surrounded by the post wall 123p and the barriers 123q1 and 123q2 and is located in the vicinity of the input opening 121a1, functions as the resonator 123d1. The resonators 113d1 and 123d1 constitute a band-pass filter which selectively transmits an electromagnetic wave whose frequency belongs to a specific band.

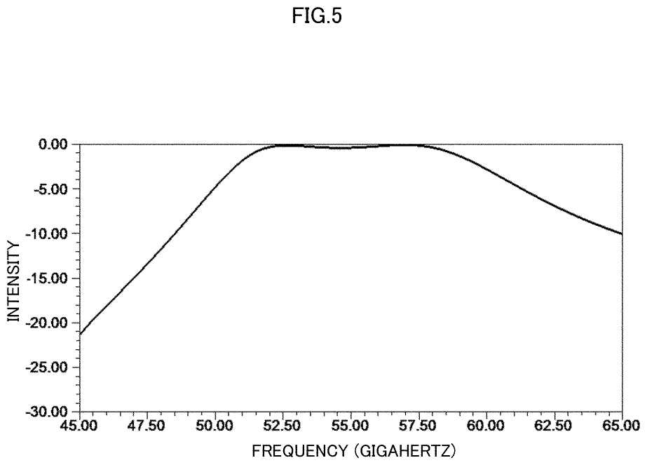

A transmission band of the band-pass filter constituted by the resonators 113d1 and 123d1 can be adjusted by changing lengths (lengths measured along the y axis) and locations of the barriers 113q1 and 113q2, included in the post wall 113p of the split circuit board 11, and the barriers 123q1 and 123q2, included in the post wall 123p of the antenna circuit board 12. For example, in a case where the lengths (lengths measured along the y axis) and the locations of the barriers 113q1, 113q2, 123q1, and 123q2 are set so that the transmission band of the band-pass filter, constituted by the resonators 113d1 and 123d1, becomes 55 GHz±2.5 GHz, a frequency characteristic of an electromagnetic wave radiated from the waveguide slot array antenna 1 becomes as shown by a graph in FIG. 5.

[Variation 1]

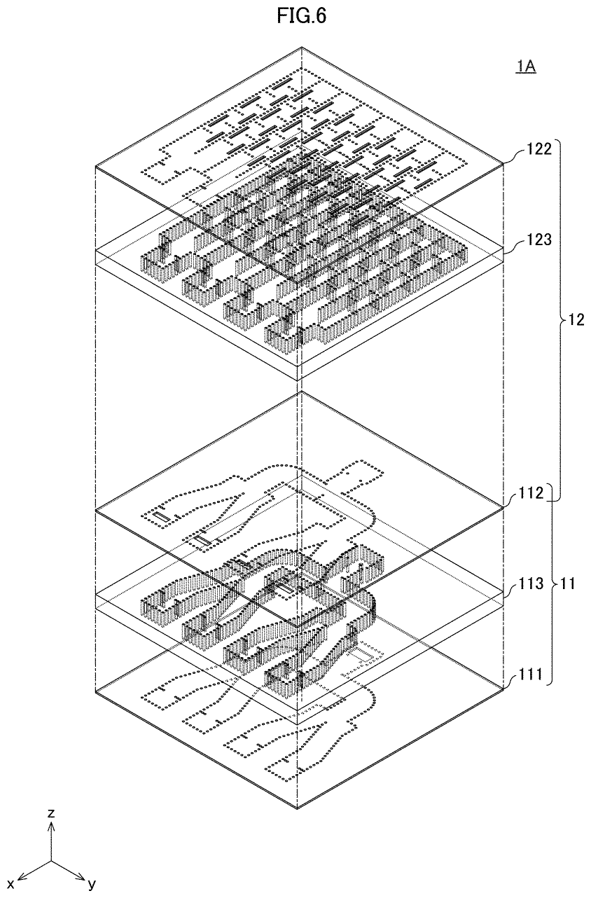

Variation 1 of the waveguide slot array antenna 1 will be described below with reference to FIG. 6. FIG. 6 is an exploded perspective view of a waveguide slot array antenna 1A in accordance with Variation 1.

The waveguide slot array antenna 1A in accordance with Variation 1 is one that is obtained by omitting the third conductor layer 121 from the waveguide slot array antenna 1 illustrated in FIG. 1. According to the waveguide slot array antenna 1A in accordance with Variation 1, a split circuit board 11 is constituted by a first dielectric layer 113, a first conductor layer 111 which covers a lower surface of the first dielectric layer 113, and a second conductor layer 112 which covers an upper surface of the first dielectric layer 113. An antenna circuit board 12 is constituted by a second dielectric layer 123, the second conductor layer 112 which covers a lower surface of the second dielectric layer 123, and a fourth conductor layer 122 which covers an upper surface of the second dielectric layer 123. That is, the split circuit board 11 and the antenna circuit board 12 are provided on one another without interposition of a joining layer 13 therebetween, and the second conductor layer 112 of the split circuit board 11 also functions as a third conductor layer 121 of the antenna circuit board 12.

According to Variation 1, it is possible to cause the waveguide slot array antenna 1A, having a function equivalent to that of the waveguide slot array antenna 1, to be thinner than the waveguide slot array antenna 1 illustrated in FIG. 1.

[Variation 2]

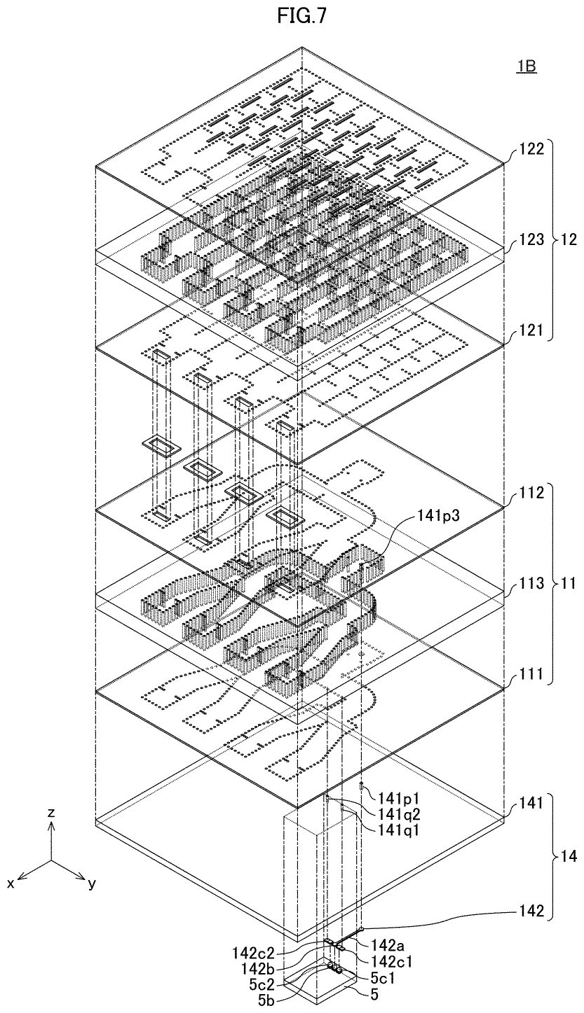

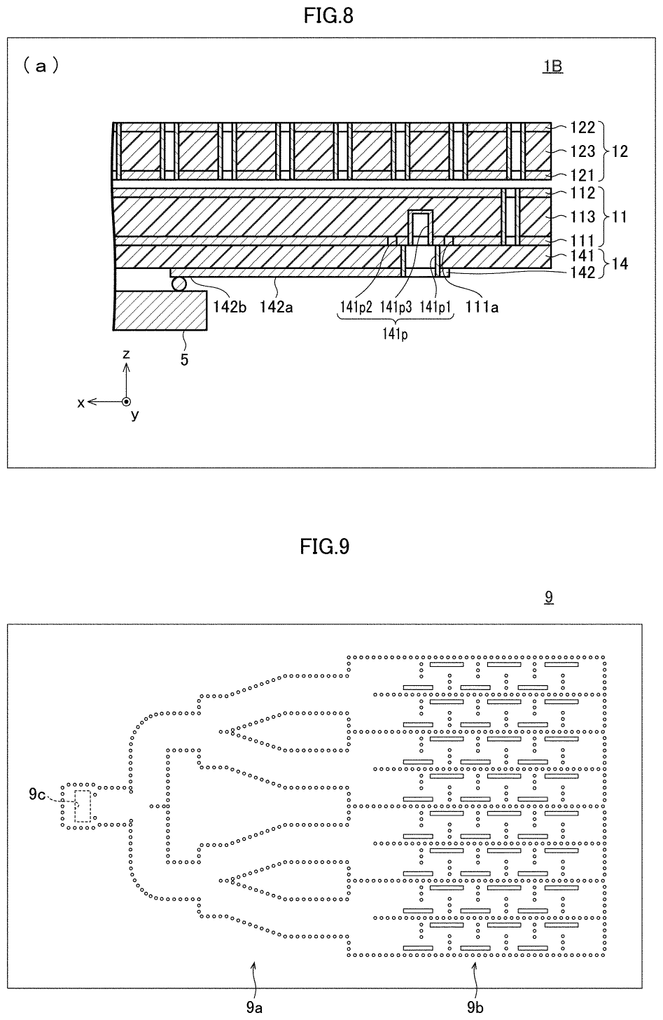

Variation 2 of the waveguide slot array antenna 1 will be described below with reference to FIGS. 7 and 8. FIG. 7 is an exploded perspective view of a waveguide slot array antenna 1B in accordance with Variation 2. FIG. 8 is a cross-sectional view of the waveguide slot array antenna 1B in accordance with Variation 2.

The waveguide slot array antenna 1B in accordance with Variation 2 is one that is obtained by adding a microstrip line 14 to the waveguide slot array antenna 1 illustrated in FIG. 1. The microstrip line 14 is constituted by (i) a third dielectric layer 141 whose upper surface is covered by a first conductor layer 111 and (ii) a fifth conductor layer 142 which is formed on a lower surface of the third dielectric layer 141. A material of the third dielectric layer 141 can be, for example, glass such as quartz glass. A material of the fifth conductor layer 142 can be, for example, metal such as copper.

A conductor post 141p1 is formed in the third dielectric layer 141. The conductor post 141p1 is a through-via whose upper end reaches the upper surface of the third dielectric layer 141 and whose lower end reaches the lower surface of the third dielectric layer 141. The upper end of the conductor post 141p1 is connected to a land 141p2 formed on the upper surface of the third dielectric layer 141. A conductor post 141p3 is formed also in a first dielectric layer 113. The conductor post 141p3 is a blind via whose lower end reaches a lower surface of the first dielectric layer 113, and is located in an input waveguide of a T branch 113b. The lower end of the conductor post 141p3 is connected to the conductor post 141p1 via the land 141p2. The conductor post 141p1, the land 141p2, and the conductor post 141p3 constitute a power feeding pin 141p for inputting an electromagnetic wave into a split circuit board 11. Note that the land 141p2 is formed in an input opening 111a of the first conductor layer 111, and the power feeding pin 141p is electrically insulated from the first conductor layer 111.

The fifth conductor layer 142 is a conductor pattern printed on a lower surface of the third dielectric layer 141, and includes a signal line 142a, a signal pad 142b, and ground pads 142c1 and 142c2. The signal line 142a is a strip-shaped conductor, and an end of the signal line 142a which end is located in a negative direction of an x axis is connected to a lower end of the power feeding pin 141p. The signal pad 142b is a planar square conductor, and a side of the signal pad 142b is connected to an end of the signal line 142a which end is located in a positive direction of the x axis. The ground pad 142c1 is a planar square conductor, and is provided so that a side of the ground pad 142c1 faces, without being in contact with, a side of the signal pad 142b which side is located in a positive direction of a y axis. The ground pad 142c2 is a planar square conductor, and is provided so that a side of the ground pad 142c2 faces, without being in contact with, a side of the signal pad 142b which side is located in a negative direction of the y axis. The ground pads 142c1 and 142c2 are short-circuited to the first conductor layer 111 via conductor posts 141q1 and 141q2, respectively, which are formed in the third dielectric layer 141.

An integrated circuit 5 can be connected to the waveguide slot array antenna 1B in accordance with Variation 2. More specifically, a signal terminal 5b of the integrated circuit 5 can be connected to the signal pad 142b of the waveguide slot array antenna 1B with use of a solder bump or the like, and ground terminals 5c1 and 5c2 of the integrated circuit 5 can be connected to the ground pads 142c1 and 142c2, respectively, of the waveguide slot array antenna 1B with use of solder bumps or the like. This makes it possible to supply a high frequency signal generated in the integrated circuit 5 to the waveguide slot array antenna 1B without causing reflection of a signal due to parasitic inductance.

In the waveguide slot array antenna 1B, a high frequency signal outputted from the integrated circuit 5 is (i) transmitted through the microstrip line 14 as an electromagnetic wave in a TEM mode, (ii) converted into an electromagnetic wave in a TE mode in the power feeding pin 141p, and then (iii) inputted into a post-wall waveguide 113a of the split circuit board 11. This electromagnetic wave is radiated through a slot array 122a after propagating through the post-wall waveguide 113a of the split circuit board 11 and a post-wall waveguide 123a of an antenna circuit board 12.

[Other Variations]

In Embodiment 1, an aspect has been described in which the number of output openings constituting the output opening group 112a of the split circuit board 11 and the number of input openings constituting the input opening group 121a of the antenna circuit board 12 are each four. However, the present invention is not limited to such an aspect. That is, the number of output openings constituting the output opening group 112a of the split circuit board 11 and the number of input openings constituting the input opening group 121a of the antenna circuit board 12 can be any number.

In Embodiment 1, an aspect has been described in which the post-wall waveguide 113a of the split circuit board 11 is constituted by the T branch 113b and the Y branches 113c1 and 113c2. However, the present invention is not limited to such an aspect. That is, a shape of a branch, the number of branches, and order of branches which constitute(s) the post-wall waveguide 113a of the split circuit board 11 can be any shape, any number, and any order. For example, the post-wall waveguide 113a of the split circuit board 11 can be constituted by one or more Y branches, or can be alternatively constituted by one or more T branches, or can be alternatively constituted by a combination of one or more T branches and one or more Y branches.

In Embodiment 1, an aspect has been described in which the Y branches 123b1 through 123b4, which are arranged in a single stage, are provided to the antenna circuit board 12 so that the number of output waveguides constituting a output waveguide group 123c is twice as large as the number of input openings constituting the input opening group 121a. However, the present invention is not limited to such an aspect. That is, the number of output waveguides constituting the output waveguide group 123c can be caused to be identical to the number of input openings constituting the input opening group 121a, without providing a Y branch to the antenna circuit board 12. Alternatively, N stages (N is a natural number of 2 or more) of Y branches can be provided to the antenna circuit board 12 so that the number of output waveguides constituting the output waveguide group 123c is 2^{N} times as larger as the number of input openings constituting the input opening group 121a.

Moreover, in Embodiment 1, an aspect has been described in which the resonators are arranged in two stages at the connection between the split circuit board 11 and the antenna circuit board 12. However, the present invention is not limited to such an aspect. That is, the number of stages of resonators arranged at the connection between the split circuit board 11 and the antenna circuit board 12 can be any number. In Embodiment 1, an aspect has been described in which the number of stages of the resonators arranged on a split-circuit-board-11 side is identical to the number of stages of the resonators arranged on an antenna-circuit-board-12 side (a single stage for each side). However, the present invention is not limited to such an aspect. That is, the number of stages of resonators arranged on the split-circuit-board-11 side and the number of stages of resonators arranged on the antenna-circuit-board-12 side can be different from each other. For example, an aspect can be realized in which a single stage of resonators are arranged on the split-circuit-board-11 side and two stages of resonators are arranged on the antenna-circuit-board-12 side.

Aspects of the present invention can also be expressed as follows:

A waveguide slot array antenna (1, 1A, 1B) in accordance with an aspect of the present invention is a waveguide slot array antenna, including: a first substrate (11) to which a first waveguide (113a) is provided, the first waveguide (113a) being configured to cause an electromagnetic wave, inputted through an input opening (111a), to be split; and a second substrate (12) to which a second waveguide (123a) is provided, the second waveguide (123a) being configured to guide, to a slot array (122a), the electromagnetic wave split in the first waveguide (113a), the first substrate (11) and the second substrate (12) being joined to each other so that the first waveguide (113a) and the second waveguide (123a) at least overlap each other.

According to the above configuration, it is possible to make a plan view size of the waveguide slot array antenna smaller than that of a conventional waveguide slot array antenna having a branch waveguide similar to the first waveguide.

The waveguide slot array antenna (1, 1A, 1B) in accordance with an aspect of the present invention is preferably arranged such that the first substrate (11) and the second substrate (12) are joined to each other so that a direction in which the electromagnetic wave travels in the first waveguide (113a) is opposite to a direction in which the electromagnetic wave travels in the second waveguide (123a).

According to the above configuration, it is possible to further reduce the plan view size of the waveguide slot array antenna.

The waveguide slot array antenna (1, 1A, 1B) in accordance with an aspect of the present invention is preferably arranged such that a resonator (113d1 through 113d4, 123d1 through 123d4) is formed in one or both of the first waveguide (113a) and the second waveguide (123a).

According to the above configuration, it is possible to cause the waveguide slot array antenna to have a band-pass-filter function.

The waveguide slot array antenna (1) in accordance with an aspect of the present invention is preferably arranged such that the first substrate (11) is constituted by a first dielectric layer (113) in which the first waveguide (113a) is formed, a first conductor layer (111) which covers a lower surface of the first dielectric layer (113) and in which the input opening (111a) is formed, and a second conductor layer (112) which covers an upper surface of the first dielectric layer (113) and in which an output opening group (112a) is formed; the first waveguide (113a) is configured to guide, to the output opening group (112a), the electromagnetic wave inputted through the input opening (111a); the second substrate (12) is constituted by a second dielectric layer (123) in which the second waveguide (123a) is formed, a third conductor layer (121) which covers a lower surface of the second dielectric layer (123) and in which an input opening group (121a) is formed, and a fourth conductor layer (122) which covers an upper surface of the second dielectric layer (123) and in which the slot array (122a) is formed; the second waveguide (123a) is configured to guide, to the slot array (122a), the electromagnetic wave inputted through the input opening group (121a); and the second conductor layer (112) and the third conductor layer (121) are joined to each other so that output openings (112a1 through 112a4) constituting the output opening group (112a) are in alignment with respective input openings (121a1 through 121a4) constituting the input opening group (121a).

According to the above configuration, it is possible to make the waveguide slot array antenna thinner.

The waveguide slot array antenna (1) in accordance with an aspect of the present invention is preferably arranged such that the second conductor layer (112) and the third conductor layer (121) are connected to each other with use of connecting conductors (131 through 134) which surround the respective output openings (112a1 through 112a4) constituting the output opening group (112a) and which surround the respective input openings (121a1 through 121a4) constituting the input opening group (121a) and being in alignment with the respective output openings (112a1 through 112a4).

According to the above configuration, it is possible to suppress leakage of an electromagnetic wave which leakage can occur between the first substrate and the second substrate.

The waveguide slot array antenna (1) in accordance with an aspect of the present invention is preferably arranged such that a space surrounded by each of the connecting conductors (131 through 134) is filled with a dielectric material.

According to the above configuration, it is possible to broaden a transmission bandwidth of a band-pass filter constituted by a resonator(s) formed in one or both of the first waveguide and the second waveguide.

The waveguide slot array antenna (1A) in accordance with an aspect of the present invention is preferably arranged such that the first substrate (11) is constituted by a first dielectric layer (113) in which the first waveguide (113a) is formed, a first conductor layer (111) which covers a lower surface of the first dielectric layer (113) and in which the input opening (111a) is formed, and a second conductor layer (112) which covers an upper surface of the first dielectric layer (113) and in which an opening group is formed; the first waveguide (113a) is configured to guide, to the opening group, the electromagnetic wave inputted through the input opening (111a); the second substrate (12) is constituted by a second dielectric layer (123) in which the second waveguide (123a) is formed, the second conductor layer (112) which covers a lower surface of the second dielectric layer (123), and a fourth conductor layer (122) which covers an upper surface of the second dielectric layer (123) and in which the slot array (122a) is formed; and the second waveguide (123a) is configured to guide, to the slot array (122a), the electromagnetic wave inputted through the opening group.

According to the above configuration, it is possible to make the waveguide slot array antenna much thinner.

The waveguide slot array antenna (1B) in accordance with an aspect of the present invention is preferably arranged so as to further include a microstrip line (14) constituted by (i) a third dielectric layer (141) whose upper surface is covered by the first conductor layer (111) and (ii) a signal line (142a) which is formed on a lower surface of the third dielectric layer (141) and which is connected to a power feeding pin (141p) passing through the third dielectric layer (141) and extending into the first dielectric layer (113) through the input opening (111a).

According to the above configuration, it is possible to connect an integrated circuit to the waveguide slot array antenna.

The waveguide slot array antenna (1, 1A, 1B) in accordance with an aspect of the present invention is preferably arranged such that one or both of the first dielectric layer (113) and the second dielectric layer (123) are made of quartz glass.

According to the above configuration, it is possible to suppress dielectric loss of the waveguide slot array antenna.

The waveguide slot array antenna (1, 1A, 1B) in accordance with an aspect of the present invention is preferably arranged such that one or both of the first waveguide (113a) and the second waveguide (123a) are each a post-wall waveguide having a post wall (113p, 123p) as a narrow wall.

According to the above configuration, it is possible to make the waveguide slot array antenna lighter in weight.

[Supplementary Note]

The present invention is not limited to the embodiment above, and can be altered by a skilled person in the art within the scope of the claims. Any embodiment derived by combining technical means disclosed as the embodiment above and its variations is also encompassed in the technical scope of the present invention.

### REFERENCE SIGNS LIST

1 Waveguide slot array antenna
11 Split circuit board (first substrate)
111 First conductor layer
111a Input opening
112 Second conductor layer
112a Output opening group
113 First dielectric layer
113a Post-wall waveguide
113b T branch
113c1 and 113c2 Y branch
113d1 through 113d4 Resonator
113p Post wall
12 Antenna circuit board
121 Third conductor layer
121a Input opening group
122 Fourth conductor layer
122a Slot array
123 Second dielectric layer
123a Post-wall waveguide
123b1 through 123b4 Y branch
123c1 through 123c8 output waveguide
123d1 through 123d4 Resonator
13 Joining layer
131 through 134 Joining conductor
14 Microstrip line
141 Third dielectric layer
142 Fifth conductor layer
142a Signal line
141p Power feeding pin

1. A waveguide slot array antenna, comprising:
a first substrate to which a first waveguide is provided, the first waveguide being configured to cause an electromagnetic wave, inputted through an input opening, to be split; and
a second substrate to which a second waveguide is provided, the second waveguide being configured to guide, to a slot array, the electromagnetic wave split in the first waveguide,
the first substrate and the second substrate being joined to each other so that the first waveguide and the second waveguide at least overlap each other.

2. The waveguide slot array antenna as set forth in claim 1, wherein the first substrate and the second substrate are joined to each other so that a direction in which the electromagnetic wave travels in the first waveguide is opposite to a direction in which the electromagnetic wave travels in the second waveguide.

3. The waveguide slot array antenna as set forth in claim 1, wherein a resonator is formed in one or both of the first waveguide and the second waveguide.

4. The waveguide slot array antenna as set forth in claim 3, wherein:
the first substrate is constituted by a first dielectric layer in which the first waveguide is formed, a first conductor layer which covers a lower surface of the first dielectric layer and in which the input opening is formed, and a second conductor layer which covers an upper surface of the first dielectric layer and in which an output opening group is formed;
the first waveguide is configured to guide, to the output opening group, the electromagnetic wave inputted through the input opening;
the second substrate is constituted by a second dielectric layer in which the second waveguide is formed, a third conductor layer which covers a lower surface of the second dielectric layer and in which an input opening group is formed, and a fourth conductor layer which covers an upper surface of the second dielectric layer and in which the slot array is formed;
the second waveguide is configured to guide, to the slot array, the electromagnetic wave inputted through the input opening group; and
the second conductor layer and the third conductor layer are joined to each other so that output openings constituting the output opening group are in alignment with respective input openings constituting the input opening group.

5. The waveguide slot array antenna as set forth in claim 4, wherein the second conductor layer and the third conductor layer are connected to each other with use of connecting conductors which surround the respective output openings constituting the output opening group and which surround the respective input openings constituting the input opening group and being in alignment with the respective output openings.

6. The waveguide slot array antenna as set forth in claim 5, wherein a space surrounded by each of the connecting conductors is filled with a dielectric material.

7. The waveguide slot array antenna as set forth in claim 1, wherein:
the first substrate is constituted by a first dielectric layer in which the first waveguide is formed, a first conductor layer which covers a lower surface of the first dielectric layer and in which the input opening is formed, and a second conductor layer which covers an upper surface of the first dielectric layer and in which an opening group is formed;
the first waveguide is configured to guide, to the opening group, the electromagnetic wave inputted through the input opening;
the second substrate is constituted by a second dielectric layer in which the second waveguide is formed, the second conductor layer which covers a lower surface of the second dielectric layer, and a fourth conductor layer which covers an upper surface of the second dielectric layer and in which the slot array is formed; and
the second waveguide is configured to guide, to the slot array, the electromagnetic wave inputted through the opening group.

8. The waveguide slot array antenna as set forth in claim 1, further comprising a microstrip line which includes a signal line that is connected to a power feeding pin extending into the first waveguide.

9. The waveguide slot array antenna as set forth in claim 1, wherein one or both of the first waveguide and the second waveguide are made of quartz glass.

10. The waveguide slot array antenna as set forth in claim 1, wherein one or both of the first waveguide and the second waveguide are each a post-wall waveguide having a post wall as a narrow wall.
